(19) United States
(12) Patent Application Publication
(10) Pub. No.: US 2023/0300756 A1
(43) Pub. Date: Sep. 21, 2023

(54) PRIORITIZATIONS FOR TRANSMISSION POWER REDUCTIONS IN CARRIER AGGREGATION FOR SIMULTANEOUS TRANSMISSIONS

(71) Applicant: QUALCOMM Incorporated, San Diego, CA (US)

(72) Inventors: Mostafa KHOSHNEVISAN, San Diego, CA (US); Jing SUN, San Diego, CA (US); Xiaoxia ZHANG, San Diego, CA (US)

(21) Appl. No.: 18/158,793

(22) Filed: Jan. 24, 2023

Related U.S. Application Data
(60) Provisional application No. 63/269,384, filed on Mar. 15, 2022.

(51) Int. Cl. H04W 52/28; H04W 52/14; H04W 52/34

(52) U.S. Cl. CPC H04W 52/28; H04W 52/146; H04W 52/346

(57) ABSTRACT

Various aspects of the present disclosure generally relate to wireless communication. In some aspects, a user equipment (UE) may determine a power allocation for a first uplink transmission in a component carrier that at least partially overlaps in time with a second uplink transmission in the component carrier, wherein the power allocation is determined based at least in part on a priority order that includes a priority for index values associated with time-domain overlapping uplink transmissions in a same component carrier. The UE may transmit the first uplink transmission in the component carrier based at least in part on the power allocation. Numerous other aspects are described.

### CROSS-REFERENCE TO RELATED APPLICATION

This patent application claims priority to U.S. Provisional Patent Application No. 63/269,384, filed on Mar. 15, 2022, entitled “PRIORITIZATIONS FOR TRANSMISSION POWER REDUCTIONS IN CARRIER AGGREGATION FOR SIMULTANEOUS TRANSMISSIONS,” and assigned to the assignee hereof. The disclosure of the prior Application is considered part of and is incorporated by reference into this patent application.

### FIELD OF THE DISCLOSURE

Aspects of the present disclosure generally relate to wireless communication and to techniques and apparatuses for prioritizations for transmission power reductions in carrier aggregation (CA) for simultaneous transmissions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a UE. The method may include determining a power allocation for a first uplink transmission in a component carrier that at least partially overlaps in time with a second uplink transmission in the component carrier, where the power allocation is determined based at least in part on a priority order that includes a priority for index values associated with time-domain overlapping uplink transmissions in a same component carrier. The method may include transmitting the first uplink transmission in the component carrier based at least in part on the power allocation.

Some aspects described herein relate to a method of wireless communication performed by a UE. The method may include determining a power allocation for a first uplink transmission in a component carrier that at least partially overlaps in time with a second uplink transmission in the component carrier, where the power allocation is determined based at least in part on a priority order, and where the first uplink transmission is associated with a first index value associated with time-domain overlapping uplink transmissions in a same component carrier. The method may include transmitting the first uplink transmission in the component carrier based at least in part on the power allocation.

Some aspects described herein relate to a UE for wireless communication. The UE may include a memory and one or more processors coupled to the memory. The one or more processors may be configured to determine a power allocation for a first uplink transmission in a component carrier that at least partially overlaps in time with a second uplink transmission in the component carrier. The one or more processors may be configured to transmit the first uplink transmission in the component carrier based at least in part on the power allocation.

Some aspects described herein relate to a UE for wireless communication. The UE may include a memory and one or more processors coupled to the memory. The one or more processors may be configured to determine a power allocation for a first uplink transmission in a component carrier that at least partially overlaps in time with a second uplink transmission in the component carrier. The one or more processors may be configured to transmit the first uplink transmission in the component carrier based at least in part on the power allocation.

Some aspects described herein relate to a non-transitory computer-readable medium that stores a set of instructions for wireless communication by a UE. The set of instructions, when executed by one or more processors of the UE, may cause the UE to determine a power allocation for a first uplink transmission in a component carrier that at least partially overlaps in time with a second uplink transmission in the component carrier. The set of instructions, when executed by one or more processors of the UE, may cause the UE to transmit the first uplink transmission in the component carrier based at least in part on the power allocation.

Some aspects described herein relate to a non-transitory computer-readable medium that stores a set of instructions for wireless communication by a UE. The set of instructions, when executed by one or more processors of the UE, may cause the UE to determine a power allocation for a first uplink transmission in a component carrier that at least partially overlaps in time with a second uplink transmission in the component carrier. The set of instructions, when executed by one or more processors of the UE, may cause the UE to transmit the first uplink transmission in the component carrier based at least in part on the power allocation.

Some aspects described herein relate to an apparatus for wireless communication. The apparatus may include means for determining a power allocation for a first uplink transmission in a component carrier that at least partially overlaps in time with a second uplink transmission in the component carrier, where the power allocation is determined based at least in part on a priority order that includes a priority for index values associated with time-domain overlapping uplink transmissions in a same component carrier. The apparatus may include means for transmitting the first uplink transmission in the component carrier based at least in part on the power allocation.

Some aspects described herein relate to an apparatus for wireless communication. The apparatus may include means for determining a power allocation for a first uplink transmission in a component carrier that at least partially overlaps in time with a second uplink transmission in the component carrier, where the power allocation is determined based at least in part on a priority order, and where the first uplink transmission is associated with a first index value associated with time-domain overlapping uplink transmissions in a same component carrier. The apparatus may include means for transmitting the first uplink transmission in the component carrier based at least in part on the power allocation.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 illustrates an example logical architecture of a distributed radio access network (RAN), in accordance with the present disclosure.

FIG. 4 is a diagram illustrating an example 400 of multi-transmission/reception point (TRP) communication, in accordance with the present disclosure.

FIG. 5 is a diagram illustrating an example of TRP differentiation at a UE based at least in part on a control resource set (CORESET) pool index, in accordance with the present disclosure.

FIGS. 6 and 7 are diagrams illustrating examples associated with prioritizations for transmission power reductions in CA for simultaneous transmissions, in accordance with the present disclosure.

FIGS. 8 and 9 are diagrams illustrating example processes associated with prioritizations for transmission power reductions in CA for simultaneous transmissions, in accordance with the present disclosure.

FIG. 10 is a diagram of an example apparatus for wireless communication, in accordance with the present disclosure.

FIG. 11 is a diagram illustrating an example disaggregated base station architecture, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

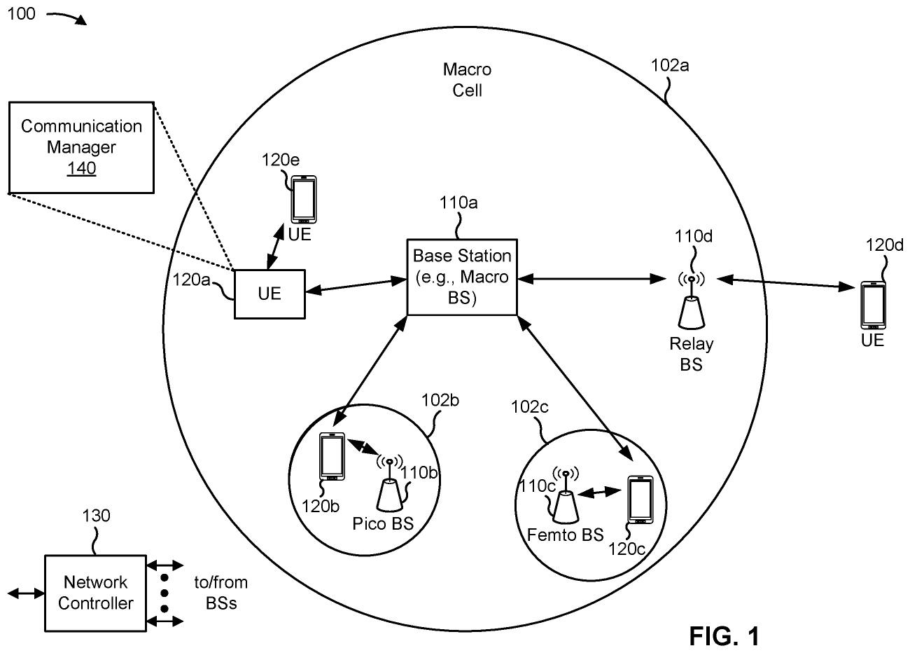

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

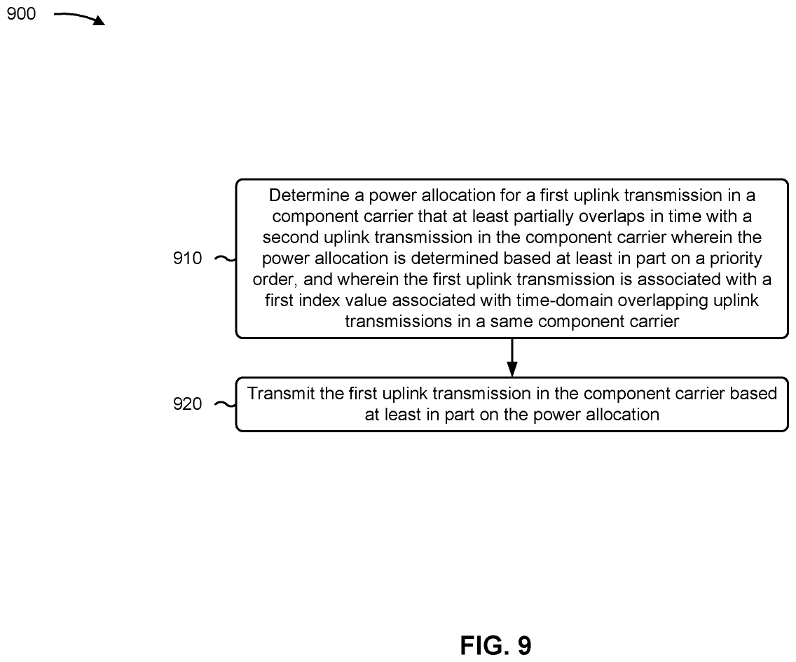

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may determine a power allocation for a first uplink transmission in a component carrier that at least partially overlaps in time with a second uplink transmission in the component carrier, wherein the power allocation is determined based at least in part on a priority order that includes a priority for index values associated with time-domain overlapping uplink transmissions in a same component carrier; and transmit the first uplink transmission in the component carrier based at least in part on the power allocation. Additionally, or alternatively, the communication manager 140 may perform one or more other operations described herein.

In some aspects, as described in more detail elsewhere herein, the communication manager 140 may determine a power allocation for a first uplink transmission in a component carrier that at least partially overlaps in time with a second uplink transmission in the component carrier, wherein the power allocation is determined based at least in part on a priority order, and wherein the first uplink transmission is associated with a first index value associated with time-domain overlapping uplink transmissions in a same component carrier; and transmit the first uplink transmission in the component carrier based at least in part on the power allocation. Additionally, or alternatively, the communication manager 140 may perform one or more other operations described herein.

As indicated above, FIG. 1 is provided as an example. Other examples may differ from what is described with regard to FIG. 1.

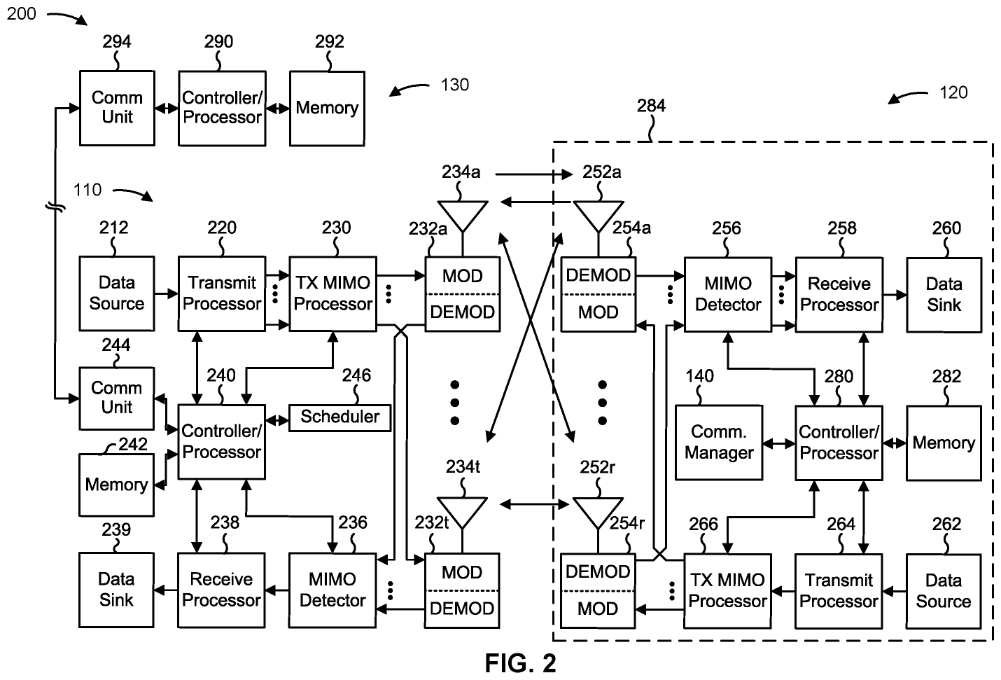

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

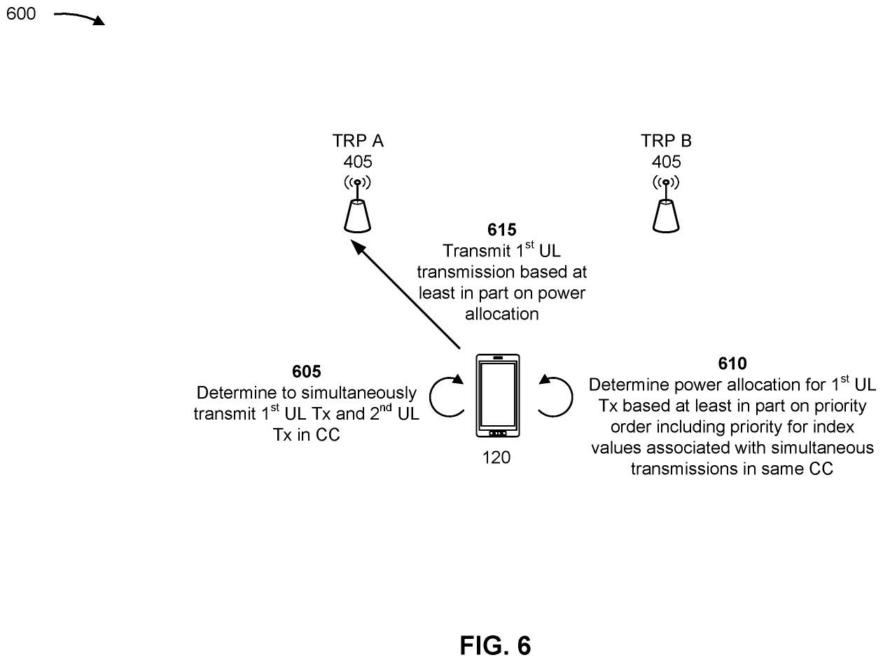

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-10).

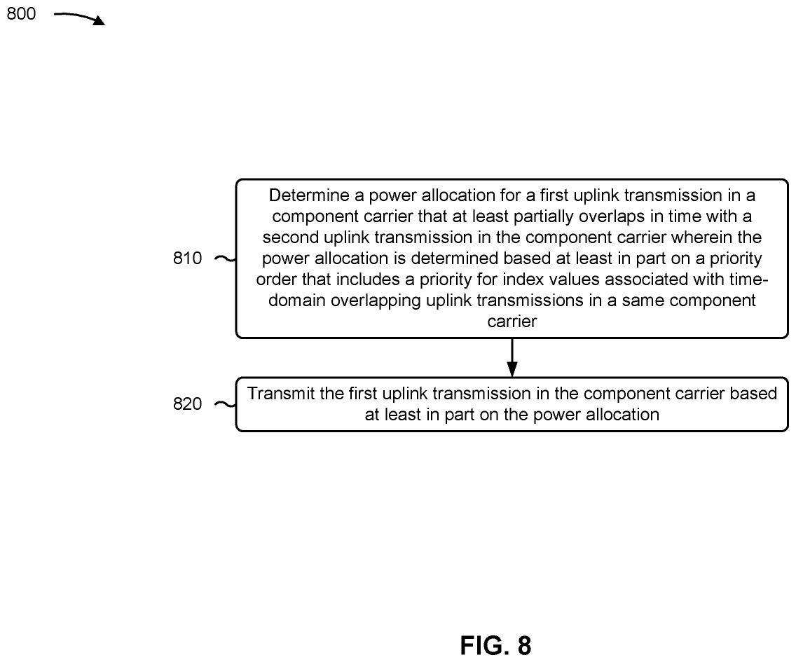

The controller/processor 240 of the base station 110, the controller/processor 280 of the UE 120, and/or any other component(s) of FIG. 2 may perform one or more techniques associated with prioritizations for transmission power reductions in CA for simultaneous transmissions, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE includes means for determining a power allocation for a first uplink transmission in a component carrier that at least partially overlaps in time with a second uplink transmission in the component carrier, wherein the power allocation is determined based at least in part on a priority order that includes a priority for index values associated with time-domain overlapping uplink transmissions in a same component carrier; and/or means for transmitting the first uplink transmission in the component carrier based at least in part on the power allocation. In some aspects, the UE includes means for determining a power allocation for a first uplink transmission in a component carrier that at least partially overlaps in time with a second uplink transmission in the component carrier, wherein the power allocation is determined based at least in part on a priority order, and wherein the first uplink transmission is associated with a first index value associated with time-domain overlapping uplink transmissions in a same component carrier; and/or means for transmitting the first uplink transmission in the component carrier based at least in part on the power allocation. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

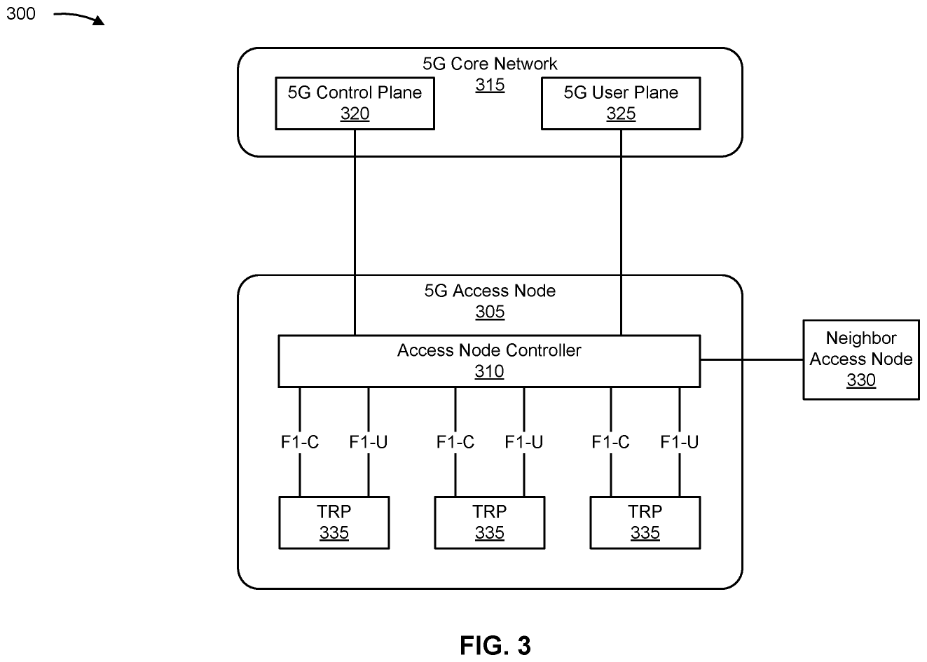

FIG. 3 illustrates an example logical architecture of a distributed RAN 300, in accordance with the present disclosure.

A 5G access node 305 may include an access node controller 310. The access node controller 310 may be a central unit (CU) of the distributed RAN 300. In some aspects, a backhaul interface to a 5G core network 315 may terminate at the access node controller 310. The 5G core network 315 may include a 5G control plane component 320 and a 5G user plane component 325 (e.g., a 5G gateway), and the backhaul interface for one or both of the 5G control plane and the 5G user plane may terminate at the access node controller 310. Additionally, or alternatively, a backhaul interface to one or more neighbor access nodes 330 (e.g., another 5G access node 305 and/or an LTE access node) may terminate at the access node controller 310.

The access node controller 310 may include and/or may communicate with one or more TRPs 335 (e.g., via an F1 Control (F1-C) interface and/or an F1 User (F1-U) interface). A TRP 335 may be a distributed unit (DU) of the distributed RAN 300. In some aspects, a TRP 335 may correspond to a base station 110 described above in connection with FIG. 1. For example, different TRPs 335 may be included in different base stations 110. Additionally, or alternatively, multiple TRPs 335 may be included in a single base station 110. In some aspects, a base station 110 may include a CU (e.g., access node controller 310) and/or one or more DUs (e.g., one or more TRPs 335). In some cases, a TRP 335 may be referred to as a cell, a panel, an antenna array, or an array.

A TRP 335 may be connected to a single access node controller 310 or to multiple access node controllers 310. In some aspects, a dynamic configuration of split logical functions may be present within the architecture of distributed RAN 300. For example, a packet data convergence protocol (PDCP) layer, a radio link control (RLC) layer, and/or a medium access control (MAC) layer may be configured to terminate at the access node controller 310 or at a TRP 335.

In some aspects, multiple TRPs 335 may transmit communications (e.g., the same communication or different communications) in the same transmission time interval (TTI) (e.g., a slot, a mini-slot, a subframe, or a symbol) or different TTIs using different QCL relationships (e.g., different spatial parameters, different transmission configuration indicator (TCI) states, different precoding parameters, and/or different beamforming parameters). In some aspects, a TCI state may be used to indicate one or more QCL relationships. A TRP 335 may be configured to individually (e.g., using dynamic selection) or jointly (e.g., using joint transmission with one or more other TRPs 335) serve traffic to a UE 120.

In some aspects, the prioritizations for transmission power reductions in CA for simultaneous transmissions can be implemented in a distributed RAN 300 such as that shown in FIG. 3.

As indicated above, FIG. 3 is provided as an example. Other examples may differ from what was described with regard to FIG. 3.

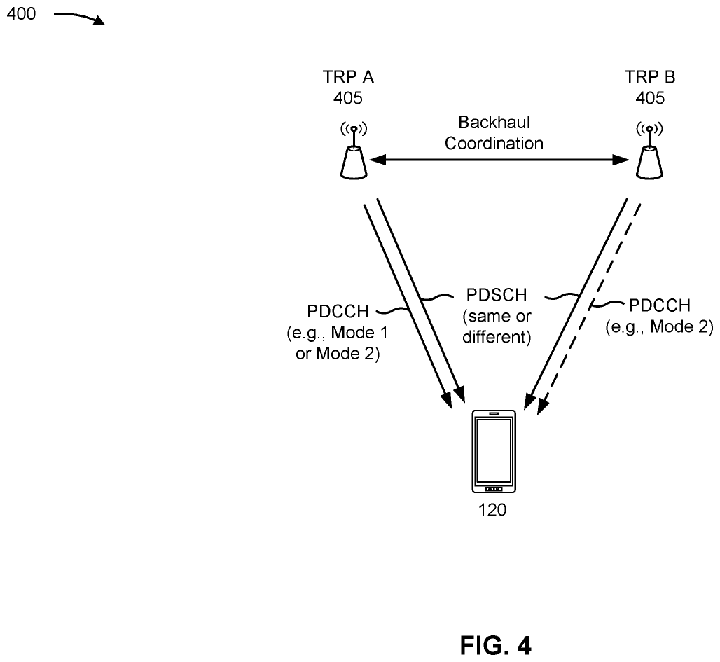

FIG. 4 is a diagram illustrating an example 400 of multi-TRP communication (sometimes referred to as multi-panel communication), in accordance with the present disclosure. As shown in FIG. 4, multiple TRPs 405 may communicate with the same UE 120. A TRP 405 may correspond to a TRP 335 described above in connection with FIG. 3.

The multiple TRPs 405 (shown as TRP A and TRP B) may communicate with the same UE 120 in a coordinated manner (e.g., using coordinated multipoint transmissions) to improve reliability and/or increase throughput. The TRPs 405 may coordinate such communications via an interface between the TRPs 405 (e.g., a backhaul interface and/or an access node controller 310). The interface may have a smaller delay and/or higher capacity when the TRPs 405 are co-located at the same base station 110 (e.g., when the TRPs 405 are different antenna arrays or panels of the same base station 110), and may have a larger delay and/or lower capacity (as compared to co-location) when the TRPs 405 are located at different base stations 110. The different TRPs 405 may communicate with the UE 120 using different QCL relationships (e.g., different TCI states), different demodulation reference signal (DMRS) ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 405 (e.g., TRP A and TRP B) may transmit communications to the UE 120 on the same PDSCH. For example, a communication may be transmitted using a single codeword with different spatial layers for different TRPs 405 (e.g., where one codeword maps to a first set of layers transmitted by a first TRP 405 and maps to a second set of layers transmitted by a second TRP 405). As another example, a communication may be transmitted using multiple codewords, where different codewords are transmitted by different TRPs 405 (e.g., using different sets of layers). In either case, different TRPs 405 may use different QCL relationships (e.g., different TCI states) for different DMRS ports corresponding to different layers. For example, a first TRP 405 may use a first QCL relationship or a first TCI state for a first set of DMRS ports corresponding to a first set of layers, and a second TRP 405 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 405, and a second PDCCH may schedule a second codeword to be transmitted by a second TRP 405. Furthermore, first DCI (e.g., transmitted by the first TRP 405) may schedule a first PDSCH communication associated with a first set of DMRS ports with a first QCL relationship (e.g., indicated by a first TCI state) for the first TRP 405, and second DCI (e.g., transmitted by the second TRP 405) may schedule a second PDSCH communication associated with a second set of DMRS ports with a second QCL relationship (e.g., indicated by a second TCI state) for the second TRP 405. In this case, DCI (e.g., having DCI format 1_0 or DCI format 1_1) may indicate a corresponding TCI state for a TRP 405 corresponding to the DCI. The TCI field of a DCI indicates the corresponding TCI state (e.g., the TCI field of the first DCI indicates the first TCI state and the TCI field of the second DCI indicates the second TCI state).

In some aspects, the prioritizations for transmission power reductions in CA for simultaneous transmissions can be implemented in a multi-TRP communication system such as that shown in FIG. 4.

As indicated above, FIG. 4 is provided as an example. Other examples may differ from what is described with respect to FIG. 4.

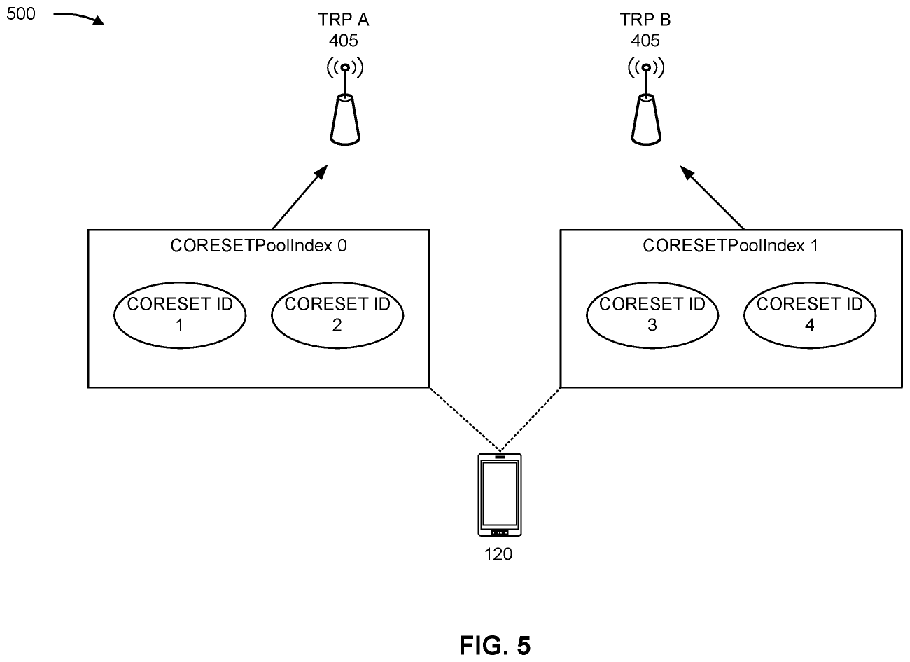

FIG. 5 is a diagram illustrating an example 500 of TRP differentiation at a UE based at least in part on a CORESET pool index, in accordance with the present disclosure. In some aspects, a CORESET pool index (or CORESETPoolIndex) value may be used by a UE (a UE 120) to identify a TRP associated with an uplink grant received on a PDCCH.

A CORESET may refer to a control region that is structured to support an efficient use of resources, such as by flexible configuration or reconfiguration of resources for one or more PDCCHs associated with a UE. In some aspects, a CORESET may occupy the first symbol of an orthogonal frequency division multiplexing (OFDM) slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using radio resource control (RRC) signaling to indicate a frequency domain region (for example, a quantity of resource blocks) or a time domain region (for example, a quantity of symbols) for the CORESET.

As illustrated in FIG. 5, a UE 120 may be configured with multiple CORESETs in a given serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 5, two or more (for example, up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP configuration, each CORESET pool index value may be associated with a particular TRP 405. As an example, and as illustrated in FIG. 5, a first TRP 405 (TRP A) may be associated with CORESET pool index 0 and a second TRP 405 (TRP B) may be associated with CORESET pool index 1. The UE 120 may be configured by a higher layer parameter, such as PDCCH-Config, with information identifying an association between a TRP and a CORESET pool index value assigned to the TRP. Accordingly, the UE may identify the TRP that transmitted a DCI uplink grant by determining the CORESET ID of the CORESET in which the PDCCH carrying the DCI uplink grant was transmitted, determining the CORESET pool index value associated with the CORESET pool in which the CORESET ID is included, and identifying the TRP associated with the CORESET pool index value.

In some aspects, the prioritizations for transmission power reductions in CA for simultaneous transmissions can be performed in a wireless communication system that implements TRP differentiation at a UE based at least in part on a CORESET pool index as described in association with FIG. 5.

As indicated above, FIG. 5 is provided as an example. Other examples may differ from what is described with respect to FIG. 5.

In some wireless communication systems, a UE may configure a maximum output power to be used for performing uplink power control. Generally, in association with performing uplink power control based on the maximum output power, the UE prioritizes some types of uplink transmissions over others. For example, for single cell operation with two uplink carriers or for operation with CA, a total UE transmit power for physical uplink shared channel (PUSCH) transmissions, physical uplink control channel (PUCCH) transmissions, physical random access channel (PRACH) transmissions, or sounding reference signal (SRS) transmissions on serving cells in a frequency range (e.g., frequency range 1 (FR1) or frequency range 2 (FR2)) in a given transmission occasion could exceed the maximum output power. In such a scenario, the UE allocates power to these uplink transmissions according to a priority order, so that the total UE transmit power for uplink transmissions on the serving cells in the frequency range is less than or equal to the maximum output power for the frequency range in every symbol of the transmission occasion. Notably, the maximum output power configured by the UE should be between a low threshold and a high threshold, with the low and high thresholds being based on a power class of the UE, maximum power reduction values, an RRC configured maximum allowable transmit power, or the like.

In some wireless communication systems, for single cell operation with two uplink carriers or for operation with CA, the UE prioritizes uplink transmissions based on the following priority order: (1) PRACH transmissions on a primary cell; (2) PUCCH or PUSCH transmissions with a higher physical (PHY) layer priority index; (3) for PUCCH or PUSCH transmissions with the same PHY layer priority index: (a) a PUCCH transmission with hybrid automatic repeat request acknowledgment (HARQ-ACK) information, a scheduling request (SR), or a link recovery request (LRR); or a PUSCH transmission with HARQ-ACK information, (b) a PUCCH transmission with channel state information (CSI) or a PUSCH transmission with CSI, (c) a PUSCH transmission without HARQ-ACK information or CSI and, for a Type-2 random access procedure, a PUSCH transmission on the primary cell; and (4) an SRS transmission, with aperiodic SRS having a higher priority than semi-persistent or periodic SRS, or a PRACH transmission on a serving cell other than the primary cell.

Further, in the case of the same priority and for operation with CA, the UE can be configured to prioritize power allocation for transmissions on the primary cell of a master cell group (MCG) or a secondary cell group (SCG) over transmissions on a secondary cell. In the case of the same priority order and for operation with two uplink carriers, the UE can be configured to prioritize power allocation for transmissions on the carrier where the UE is configured to transmit PUCCH transmissions. If the PUCCH is not configured for either of the two uplink carriers, then the UE can be configured to prioritize power allocation for transmissions on a non-supplementary uplink carrier.

Additionally, a wireless communication system may support simultaneous transmissions in CA operation. For example, a wireless communication system may support multi-DCI-based multi-TRP operation that facilitates simultaneous multi-panel uplink transmissions by a UE. According to such operations, the UE can, for example, simultaneously transmit a pair of PUSCH transmissions (PUSCH+PUSCH), where each PUSCH transmission is associated with a respective TRP and transmitted using a respective panel of the UE. As another example, the UE can simultaneously transmit a pair of PUCCH transmissions (PUCCH+PUCCH), where each PUCCH transmission is associated with a respective TRP and transmitted using a respective panel of the UE.

However, the above described priority order is for single cell operation with two uplink carriers or for operation with CA, and does not indicate prioritization for a case of simultaneous uplink transmissions in a same component carrier. For example, for PUSCH+PUSCH in the same component carrier, one or both PUSCH transmissions may or may not also carry HARQ-ACK information and/or CSI, meaning that priority among the PUSCH transmissions is not specified according to the above priority order. As another example, for PUCCH+PUCCH in the same component carrier, a first PUCCH transmission may include one or more of HARQ-ACK information, an SR, an LRR, or CSI, and the second PUCCH transmission may include one or more of HARQ-ACK information, an SR, an LRR, or CSI, meaning that priority among these PUCCH transmissions is not specified according to the above priority order. As another example, if transmission of a PUSCH transmission and a PUCCH transmission in the same component carrier is supported, then the PUSCH transmission may or may not carry HARQ-ACK information or CSI and the PUCCH transmission may include one or more of HARQ-ACK information, an SR, an LRR, or CSI, meaning that priority among the PUSCH transmission and the PUCCH transmission is not specified according to the above priority order. Notably, for simultaneous uplink transmissions in a same carrier, a UE uses different UE panels (e.g., different radio frequency (RF) chains). This may correspond to two control resource set (CORESET) pool index values (e.g., value 0 or value 1) based on an association of an uplink transmission with the CORESET pool index value, or in some cases may be determined explicitly based on a UE panel identifier (e.g., ID 0 or ID1).

Some techniques and apparatuses described herein provide prioritizations for transmission power reductions in CA for simultaneous transmissions. In some aspects, a UE may determine a power allocation for a first uplink transmission in a component carrier that at least partially overlaps in time with a second uplink transmission in the component carrier. Here, the power allocation may be determined based at least in part on a priority order that includes a priority for index values associated with time-domain overlapping uplink transmissions in a same component carrier. The UE may then transmit the first uplink transmission in the component carrier based at least in part on the power allocation. In this way, a priority order may be properly defined and used by the UE in case of simultaneous uplink transmissions in a same component carrier, thereby allowing the UE to properly and consistently control transmission power. Alternatively, in some aspects, a UE may determine a power allocation for a first uplink transmission in a component carrier that at least partially overlaps in time with a second uplink transmission in the component carrier, where the power allocation is determined based at least in part on a priority order and the first uplink transmission is associated with a first index value associated with time-domain overlapping uplink transmissions in a same component carrier. The UE may then transmit the first uplink transmission in the component carrier based at least in part on the power allocation. In this way, a priority order may be properly defined and used by the UE in case of simultaneous uplink transmissions in a same component carrier, thereby allowing the UE to properly and consistently control transmission power. Additional details are provided below.

In some aspects, the techniques and apparatuses described herein enable prioritization associated with performing uplink power control in the case of simultaneous uplink transmissions in a given component carrier for CA operation, thereby improving reliability and throughput in a wireless communication system that supports simultaneous uplink transmissions in a component carrier for CA operation.

FIG. 6 is a diagram illustrating an example 600 associated with prioritization for transmission power reductions in CA for simultaneous transmissions in a component carrier. In FIG. 6, a UE 120 is configured for multi-TRP operation associated with a first TRP 405 (e.g., TRP 405 A) and a second TRP (e.g., TRP 405 B), as described elsewhere herein. Further, in example 600, the total maximum output power across component carriers (per frequency range) is not defined per index value. That is, in example 600, the UE configured total maximum output power across component carriers is shared among panels of the UE 120 (rather than each UE panel being associated with a separate total maximum output power).

As shown by reference 605, the UE 120 may determine that the UE 120 is to transmit simultaneous uplink transmissions in a component carrier. For example, the UE 120 may receive (e.g., from the first TRP 405) first DCI that schedules a first uplink transmission in the component carrier, and may receive (e.g., from the second TRP 405) second DCI that schedules a second uplink transmission in the component carrier, where the first uplink transmission and the second uplink transmission are to be transmitted simultaneously. As used herein, simultaneous uplink transmissions are defined as two or more uplink transmissions that are to be transmitted by the UE such that the two or more uplink transmissions at least partially overlap in time (e.g., in the time domain).

In some aspects, the first uplink transmission and the second uplink transmission are each associated with a respective index value. In some aspects, the index values are CORESET pool index values. Additionally, or alternatively, the index values may be values that correspond to different panels of the UE such as panel identifiers. Thus, the index value with which a given uplink transmission is associated may depend on a CORESET pool index associated with the uplink transmission or a panel of the UE 120 that is to be used for transmitting the uplink transmission (e.g., which may depend on the TRP 405 to which the uplink transmission is to be transmitted). In some aspects, the first uplink transmission and the second uplink transmission are associated with different index values (e.g., different CORESET pool index values or different UE panel identifiers). For example, the first uplink transmission may be a PUSCH transmission for the first TRP 405, and therefore the first uplink transmission may be associated with a first index value that corresponds to a CORESET pool index value associated with the first TRP 405 or a panel of the UE 120 that is to be used to transmit to the first TRP 405. Similarly, the second uplink transmission may be a PUSCH transmission for the second TRP 405, and therefore the second uplink transmission may be associated with a second index value that corresponds to a CORESET pool index value associated with the second TRP 405 or a panel of the UE 120 that is to be used to transmit to the second TRP 405. Alternatively, in some aspects, the first uplink transmission and the second uplink transmission are associated with the same index value (e.g., the same CORESET pool index value or the same UE panel identifier).

As shown by reference 610, the UE 120 may determine a power allocation for the first uplink transmission in the component carrier. A power allocation for an uplink transmission may, for example, indicate that a UE 120 is to transmit the uplink transmission, or may indicate an amount of power or a portion of the total maximum output power that the UE 120 is to use in association with transmitting the uplink transmission. In some aspects, the UE 120 may determine the power allocation based at least in part on a priority order that includes a priority for index values associated with simultaneous (i.e., time-domain overlapping) uplink transmissions in a same component carrier.

In some aspects, the priority for the index values indicates that an uplink transmission having a first index value has a higher priority than an uplink transmission having a second index value. For example, the priority for the index value may indicate that an uplink transmission having a lower index value (e.g., a lower CORESET pool index value or lower UE panel identifier) has a higher priority than an uplink transmission having a higher index value (e.g., a higher CORESET pool index value or a higher UE panel identifier).

In some aspects, within the priority order, the priority for the index values is lower in the priority order than a priority for PHY layer priority indices of uplink transmissions and is higher in the priority order than a priority for payload types of uplink transmissions. For example, the priority order may define the following prioritization (in descending order): (1) PRACH transmissions on a primary cell; (2) PUCCH or PUSCH transmissions with a higher PHY layer priority index; (3) PUCCH or PUSCH transmissions associated with a smaller index value; (4) for PUCCH or PUSCH transmissions with the same PHY layer priority index and associated with the same index value: (a) a PUCCH transmission with HARQ-ACK information, an SR, an LRR, or a PUSCH transmission with HARQ-ACK information, (b) a PUCCH transmission with CSI or a PUSCH transmission with CSI, (c) a PUSCH transmission without HARQ-ACK information or CSI and, for a Type-2 random access procedure, a PUSCH transmission on the primary cell; and (5) an SRS transmission, with aperiodic SRS having a higher priority than semi-persistent or persistent or periodic SRS, or a PRACH transmission on a serving cell other than the primary cell.

Alternatively, in some aspects, the priority for the index values is higher in the priority order than a priority for PHY layer priority indices of uplink transmissions. For example, the priority order may define the following prioritization (in descending order): (1) PRACH transmissions on a primary cell; (2) PUCCH or PUSCH transmissions associated with a smaller index value; (3) PUCCH or PUSCH transmissions with a higher PHY layer priority index; (4) for PUCCH or PUSCH transmissions with the same PHY layer priority index and associated with the same index value: (a) a PUCCH transmission with HARQ-ACK information, an SR, an LRR, or a PUSCH transmission with HARQ-ACK information, (b) a PUCCH transmission with CSI or a PUSCH transmission with CSI, (c) a PUSCH transmission without HARQ-ACK information or CSI and, for a Type-2 random access procedure, a PUSCH transmission on the primary cell; and (5) an SRS transmission, with aperiodic SRS having a higher priority than semi-persistent or persistent or periodic SRS, or a PRACH transmission on a serving cell other than the primary cell.

Alternatively, in some aspects, the priority for the index values is lower in the priority order than a priority for payload types of uplink transmissions. For example, the priority order may define the following prioritization (in descending order): (1) PRACH transmissions on a primary cell; (2) PUCCH or PUSCH transmissions with a higher PHY layer priority index (3) for PUCCH or PUSCH transmissions with the same PHY layer priority index: (a) a PUCCH transmission with HARQ-ACK information, an SR, an LRR, or a PUSCH transmission with HARQ-ACK information, where a PUCCH/PUSCH transmission associated with the lower index value has higher priority if there are two such PUCCH/PUSCH transmissions, (b) a PUCCH transmission with CSI or a PUSCH transmission with CSI, where a PUCCH/PUSCH transmission associated with the lower index value has higher priority if there are two such PUCCH/PUSCH transmissions, (c) a PUSCH transmission without HARQ-ACK information or CSI and, for a Type-2 random access procedure, a PUSCH transmission on the primary cell, where a PUCCH/PUSCH transmission associated with the lower index value has higher priority if there are two such PUCCH/PUSCH transmissions; and (4) an SRS transmission, with aperiodic SRS having a higher priority than semi-persistent or persistent or periodic SRS, or a PRACH transmission on a serving cell other than the primary cell.

In some aspects, as illustrated in the example priority orders described above, the priority for the index values is lower in the priority order than a priority for PRACH transmissions in a primary component carrier. Further in some aspects and as illustrated in the example priority orders described above, the priority for the index values is higher in the priority order than a priority for SRS transmissions.

In some aspects, the priority order may follow a legacy priority order and include a rule that, in case of the same priority order of two time-overlapping uplink transmissions on the same component carrier (e.g., serving cell), the UE 120 is to prioritize power allocation for uplink transmissions associated with the lower index value (e.g., the lower CORESET pool index value or lower UE panel identifier). In some implementations, such a rule may be defined only for a primary cell (e.g., when the two time-overlapping uplink transmissions are on the primary cell), or for both a primary cell and a secondary cell (e.g., so long as the two time-overlapping uplink transmissions are on the same component carrier, irrespective of whether the component carrier is a primary cell or a secondary cell). Thus, in some aspects, the priority for the index values indicates that an uplink transmission having a first index value has a higher priority than an uplink transmission having a second index value based at least in part on the uplink transmission having the first index value and the uplink transmission having the second index value at least partially overlapping in time on a given component carrier and having a same priority according to a legacy priority order. In some aspects, such an aspect may be applicable to primary cells only, or may be applicable to primary cells and secondary cells.

In some aspects, as noted above, the power allocation may indicate that the UE 120 is to transmit the first uplink transmission (i.e., that the first uplink transmission is of sufficient priority such that some portion of the total maximum power to be used for transmission of the first uplink transmission), or may indicate an amount of power or a portion of the total maximum output power that the UE 120 is to use in association with transmitting the first uplink transmission. Thus, as shown by reference 615, the UE 120 may in some aspects transmit the first uplink transmission in the component carrier based at least in part on the power allocation. For example, the UE 120 may transmit the first uplink transmission with a transmit power corresponding to the power allocation as determined by the UE 120.

In some aspects, a result of the power allocation indicates that the UE 120 should refrain from transmitting an uplink transmission. For example, the UE 120 may determine, based at least in part on the priority order, that there is insufficient power to transmit the first uplink transmission (e.g., when the second uplink transmission is of higher priority and there is insufficient total maximum output power available to transmit both the first uplink transmission and the second uplink transmission). In such a case, the UE 120 may refrain from transmitting the first uplink transmission accordingly.

In some aspects, the UE 120 may perform the operations described in association with example 600 with respect to the second uplink transmission (and for any other uplink transmissions that overlap with the first uplink transmission and/or the second uplink transmission in time). For example, the UE 120 may determine a power allocation for the second uplink transmission based at least in part on the priority order that includes the priority for index values associated with time-domain overlapping uplink transmissions in a same component carrier, and may transmit or refrain from transmitting the second uplink transmission in the component carrier based at least in part on the power allocation for the second uplink transmission.

As indicated above, FIG. 6 is provided as an example. Other examples may differ from what is described with respect to FIG. 6.

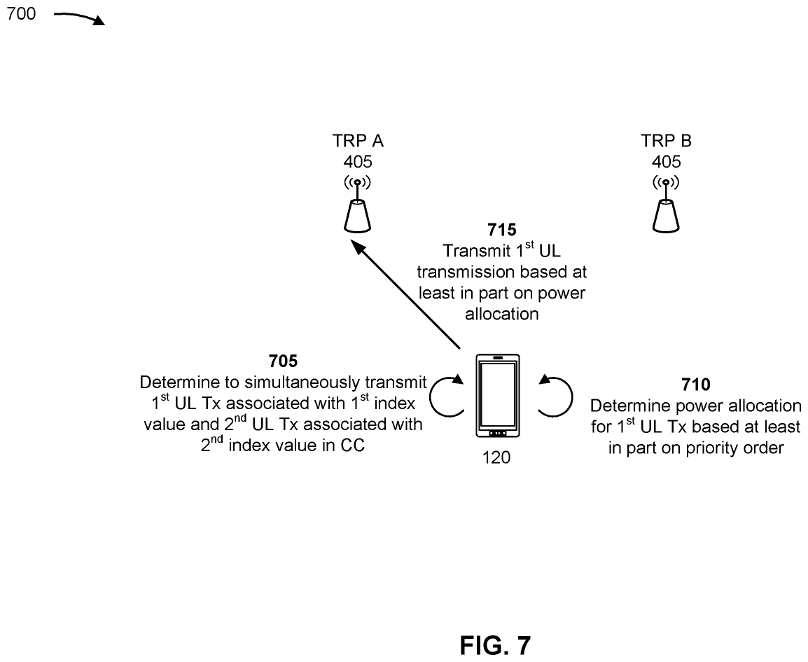

FIG. 7 is a diagram illustrating an example 700 associated with prioritization for transmission power reductions in CA for simultaneous transmissions in a component carrier. In FIG. 7, a UE 120 is configured for multi-TRP operation associated with a first TRP 405 (e.g., TRP 405 A) and a second TRP 405 (e.g., TRP 405 B), as described elsewhere herein. Further, in example 700, the total maximum output power across component carriers (per frequency range) is defined per index value. That is, in example 700, a given total maximum output power across component carriers is dedicated to a given panel of the UE 120 (i.e., each panel of the UE 120 is associated with a separate total maximum output power). Notably, in such a case, power allocation can be performed separately for each index value (e.g., for each panel of the UE 120).

As shown by reference 705, the UE 120 may determine that the UE 120 is to transmit simultaneous uplink transmissions in a component carrier. For example, the UE 120 may receive (e.g., from the first TRP 405) first DCI that schedules a first uplink transmission in the component carrier and may receive (e.g., from the second TRP 405) second DCI that schedules a second uplink transmission in the component carrier, where the first uplink transmission and the second uplink transmission are to be transmitted simultaneously.

In some aspects, the first uplink transmission and the second uplink transmission are each associated with a respective index value. In some aspects, the index values are CORESET pool index values. Additionally, or alternatively, the index values may be values that correspond to different panels of the UE such as panel identifiers. Thus, the index value with which a given uplink transmission is associated may depend on a CORESET pool index associated with the uplink transmission or a panel of the UE 120 that is to be used for transmitting the uplink transmission (e.g., which may depend on the TRP 405 to which the uplink transmission is to be transmitted). In some aspects, the first uplink transmission and the second uplink transmission are associated with different index values. Alternatively, in some aspects, the first uplink transmission and the second uplink transmission are associated with the same index value (e.g., the same CORESET pool index value or the same UE panel identifier).

In some aspects, the UE 120 may associate the first uplink transmission with the first index value based at least in part on the first uplink transmission not explicitly being associated with an index value. For example, if the first uplink transmission is not explicitly associated with a CORESET pool index value, then the UE 120 may be configured to associate the first uplink with a default CORESET pool index value (e.g., CORESET pool index value 0).

As shown by reference 710, the UE 120 may determine a power allocation for the first uplink transmission in the component carrier. In some aspects, the UE 120 may determine the power allocation based at least in part on a total maximum output power corresponding to the index value of the first uplink transmission. Notably, because a total maximum output power across component carriers is defined for each panel of the UE 120, the UE 120 may determine power allocations for uplink transmissions associated with the first index value separately from determining power allocations for uplink transmissions associated with the second index value.

In some aspects, as noted in example 700, the UE 120 may determine the power allocation based at least in part on a priority order. In some aspects, the priority order may be a legacy priority order. For example, the priority order may define the following prioritization (in descending order): (1) PRACH transmissions on a primary cell; (2) PUCCH or PUSCH transmissions with a higher PHY layer priority index; (3) for PUCCH or PUSCH transmissions with the same PHY layer priority index and associated with the same index value: (a) a PUCCH transmission with HARQ-ACK information, an SR, an LRR, or a PUSCH transmission with HARQ-ACK information, (b) a PUCCH transmission with CSI or a PUSCH transmission with CSI, (c) a PUSCH transmission without HARQ-ACK information or CSI and, for a Type-2 random access procedure, a PUSCH transmission on the primary cell; and (4) an SRS transmission, with aperiodic SRS having a higher priority than semi-persistent or persistent or periodic SRS, or a PRACH transmission on a serving cell other than the primary cell. Notably, the legacy priority order can be used because the power allocation is performed for each index value separately.

In some aspects, as noted above, the power allocation may indicate that the UE 120 is to transmit the first uplink transmission (i.e., that the first uplink is of sufficient priority such that some portion of the total maximum power is to be used for transmission of the first uplink transmission), or may indicate an amount of power or a portion of the total maximum output power that the UE 120 is to use in association with transmitting the first uplink transmission. Thus, as shown by reference 715, the UE 120 may in some aspects transmit the first uplink transmission in the component carrier based at least in part on the power allocation. For example, the UE 120 may transmit the first uplink transmission with a transmit power corresponding to the power allocation as determined by the UE 120.

In some aspects, a result of the power allocation indicates that the UE 120 should refrain from transmitting an uplink transmission. For example, the UE 120 may determine, based at least in part on the priority order, that there is insufficient power to transmit the first uplink transmission (e.g., when the second uplink transmission is of higher priority and there is insufficient total maximum output power available to transmit both the first uplink transmission and the second uplink transmission). In such a case, the UE 120 may refrain from transmitting the first uplink accordingly.

In some aspects, the UE 120 may perform operations similar to those described in association with example 700 with respect to the second uplink transmission (and for any other uplink transmissions that overlap with the first uplink transmission and/or the second uplink transmission in time). For example, the second uplink transmission may be associated with a second index value associated with time-domain overlapping uplink transmissions in a same component carrier, and the UE 120 may determine a power allocation for the second uplink transmission based at least in part on the priority order. Here, the power allocation for the second uplink transmission may be determined based at least in part on a total maximum output power defined for the second index value. The UE 120 may then transmit or refrain from transmitting the second uplink transmission in the component carrier based at least in part on the power allocation for the second uplink transmission.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with prioritizations for transmission power reductions in carrier aggregation for simultaneous transmissions.

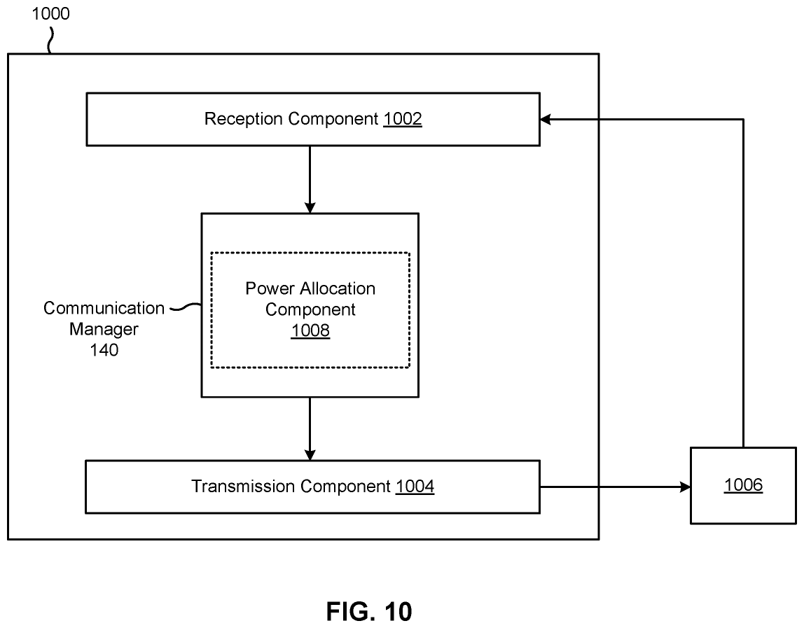

As shown in FIG. 8, in some aspects, process 800 may include determining a power allocation for a first uplink transmission in a component carrier that at least partially overlaps in time with a second uplink transmission in the component carrier, wherein the power allocation is determined based at least in part on a priority order that includes a priority for index values associated with time-domain overlapping uplink transmissions in a same component carrier (block 810). For example, the UE (e.g., using communication manager 140 and/or power allocation component 1008, depicted in FIG. 10) may determine a power allocation for a first uplink transmission in a component carrier that at least partially overlaps in time with a second uplink transmission in the component carrier, wherein the power allocation is determined based at least in part on a priority order that includes a priority for index values associated with time-domain overlapping uplink transmissions in a same component carrier, as described above. In some aspects, the power allocation is determined based at least in part on a priority order that includes a priority for index values associated with time-domain overlapping uplink transmissions in a same component carrier.

As further shown in FIG. 8, in some aspects, process 800 may include transmitting the first uplink transmission in the component carrier based at least in part on the power allocation (block 820). For example, the UE (e.g., using communication manager 140 and/or transmission component 1004, depicted in FIG. 10) may transmit the first uplink transmission in the component carrier based at least in part on the power allocation, as described above.

Process 800 may include additional aspects, such as any single aspect or any combination of aspects described below and/or in connection with one or more other processes described elsewhere herein.

In a first aspect, a total maximum output power for a plurality of component carriers that includes the component carrier is not defined per index value.

In a second aspect, alone or in combination with the first aspect, a total maximum output power for a plurality of component carriers that includes the component carrier is to be shared among a plurality of panels of the UE.

In a third aspect, alone or in combination with one or more of the first and second aspects, the index values are CORESET pool index values.

In a fourth aspect, alone or in combination with one or more of the first through third aspects, each of the index values corresponds to a different panel of the UE.

In a fifth aspect, alone or in combination with one or more of the first through fourth aspects, the priority for the index values indicates that an uplink transmission having a first index value has a higher priority than an uplink transmission having a second index value.

In a sixth aspect, alone or in combination with one or more of the first through fifth aspects, the priority for the index values is lower in the priority order than a priority for PHY layer priority indices of uplink transmissions and is higher in the priority order than a priority for payload types of uplink transmissions.

In a seventh aspect, alone or in combination with one or more of the first through sixth aspects, the priority for the index values is higher in the priority order than a priority for PHY layer priority indices of uplink transmissions.

In an eighth aspect, alone or in combination with one or more of the first through seventh aspects, the priority for the index values is lower in the priority order than a priority for payload types of uplink transmissions.

In a ninth aspect, alone or in combination with one or more of the first through eighth aspects, the priority for the index values is lower in the priority order than a priority for PRACH transmissions in a primary component carrier.

In a tenth aspect, alone or in combination with one or more of the first through ninth aspects, the priority for the index values is higher in the priority order than a priority for SRS transmissions.

In an eleventh aspect, alone or in combination with one or more of the first through tenth aspects, the priority for the index values indicates that an uplink transmission having a first index value has a higher priority than an uplink transmission having a second index value based at least in part on the uplink transmission having the first index value and the uplink transmission having the second index value at least partially overlapping in time on a given component carrier and having a same priority according to a legacy priority order.

In a twelfth aspect, alone or in combination with one or more of the first through eleventh aspects, the priority for the index values is applicable to primary cells only.

In a thirteenth aspect, alone or in combination with one or more of the first through twelfth aspects, the priority for the index values is applicable to primary cells and secondary cells.

In a fourteenth aspect, alone or in combination with one or more of the first through thirteenth aspects, process 800 includes determining a power allocation for the second uplink transmission based at least in part on the priority order that includes the priority for index values associated with time-domain overlapping uplink transmissions in a same component carrier.

In a fifteenth aspect, alone or in combination with one or more of the first through fourteenth aspects, process 800 includes transmitting the second uplink transmission in the component carrier based at least in part on the power allocation for the second uplink transmission.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with prioritizations for transmission power reductions in carrier aggregation for simultaneous transmissions.

As shown in FIG. 9, in some aspects, process 900 may include determining a power allocation for a first uplink transmission in a component carrier that at least partially overlaps in time with a second uplink transmission in the component carrier, wherein the power allocation is determined based at least in part on a priority order, and wherein the first uplink transmission is associated with a first index value associated with time-domain overlapping uplink transmissions in a same component carrier (block 910). For example, the UE (e.g., using communication manager 140 and/or power allocation component 1008, depicted in FIG. 10) may determine a power allocation for a first uplink transmission in a component carrier that at least partially overlaps in time with a second uplink transmission in the component carrier, wherein the power allocation is determined based at least in part on a priority order, and wherein the first uplink transmission is associated with a first index value associated with time-domain overlapping uplink transmissions in a same component carrier, as described above. In some aspects, the power allocation is determined based at least in part on a priority order. In some aspects, the first uplink transmission is associated with a first index value associated with time-domain overlapping uplink transmissions in a same component carrier.

As further shown in FIG. 9, in some aspects, process 900 may include transmitting the first uplink transmission in the component carrier based at least in part on the power allocation (block 920). For example, the UE (e.g., using communication manager 140 and/or transmission component 1004, depicted in FIG. 10) may transmit the first uplink transmission in the component carrier based at least in part on the power allocation, as described above.

Process 900 may include additional aspects, such as any single aspect or any combination of aspects described below and/or in connection with one or more other processes described elsewhere herein.

In a first aspect, a total maximum output power for a plurality of component carriers that includes the component carrier is defined for the first index value.

In a second aspect, alone or in combination with the first aspect, a total maximum output power for a plurality of component carriers that includes the component carrier is dedicated to a panel of the UE to be used for transmitting the first uplink transmission.

In a third aspect, alone or in combination with one or more of the first and second aspects, the first index value is a CORESET pool index value.

In a fourth aspect, alone or in combination with one or more of the first through third aspects, the first index value corresponds to a particular panel of the UE.

In a fifth aspect, alone or in combination with one or more of the first through fourth aspects, process 900 includes associating the first uplink transmission with the first index value based at least in part on the first uplink transmission not explicitly being associated with an index value.

In a sixth aspect, alone or in combination with one or more of the first through fifth aspects, process 900 includes determining a power allocation for the second uplink transmission based at least in part on the priority order, the second uplink transmission being associated with a second index value associated with time-domain overlapping uplink transmissions in a same component carrier, wherein the power allocation for the second uplink transmission is determined based at least in part on a total maximum output power for a plurality of component carriers that includes the component carrier defined for the second index value.

In a seventh aspect, alone or in combination with one or more of the first through sixth aspects, process 900 includes transmitting the second uplink transmission in the component carrier based at least in part on the power allocation for the second uplink transmission.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a power allocation component 1008, among other examples.

In some aspects, the apparatus 1000 may be configured to perform one or more operations described herein in connection with FIGS. 6 and 7. Additionally, or alternatively, the apparatus 1000 may be configured to perform one or more processes described herein, such as process 800 of FIG. 8, process 900 of FIG. 9, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The power allocation component 1008 may determine a power allocation for a first uplink transmission in a component carrier that at least partially overlaps in time with a second uplink transmission in the component carrier, wherein the power allocation is determined based at least in part on a priority order that includes a priority for index values associated with time-domain overlapping uplink transmissions in a same component carrier. The transmission component 1004 may transmit the first uplink transmission in the component carrier based at least in part on the power allocation.

The power allocation component 1008 may determine a power allocation for the second uplink transmission based at least in part on the priority order that includes the priority for index values associated with time-domain overlapping uplink transmissions in a same component carrier.

The transmission component 1004 may transmit the second uplink transmission in the component carrier based at least in part on the power allocation for the second uplink transmission.

In some aspects, the power allocation component 1008 may determine a power allocation for a first uplink transmission in a component carrier that at least partially overlaps in time with a second uplink transmission in the component carrier, wherein the power allocation is determined based at least in part on a priority order, and wherein the first uplink transmission is associated with a first index value associated with time-domain overlapping uplink transmissions in a same component carrier. The transmission component 1004 may transmit the first uplink transmission in the component carrier based at least in part on the power allocation.

The power allocation component 1008 may associate the first uplink transmission with the first index value based at least in part on the first uplink transmission not explicitly being associated with an index value.

The power allocation component 1008 may determine a power allocation for the second uplink transmission based at least in part on the priority order, the second uplink transmission being associated with a second index value associated with time-domain overlapping uplink transmissions in a same component carrier, wherein the power allocation for the second uplink transmission is determined based at least in part on a total maximum output power for a plurality of component carriers that includes the component carrier defined for the second index value.

The transmission component 1004 may transmit the second uplink transmission in the component carrier based at least in part on the power allocation for the second uplink transmission.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an JAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

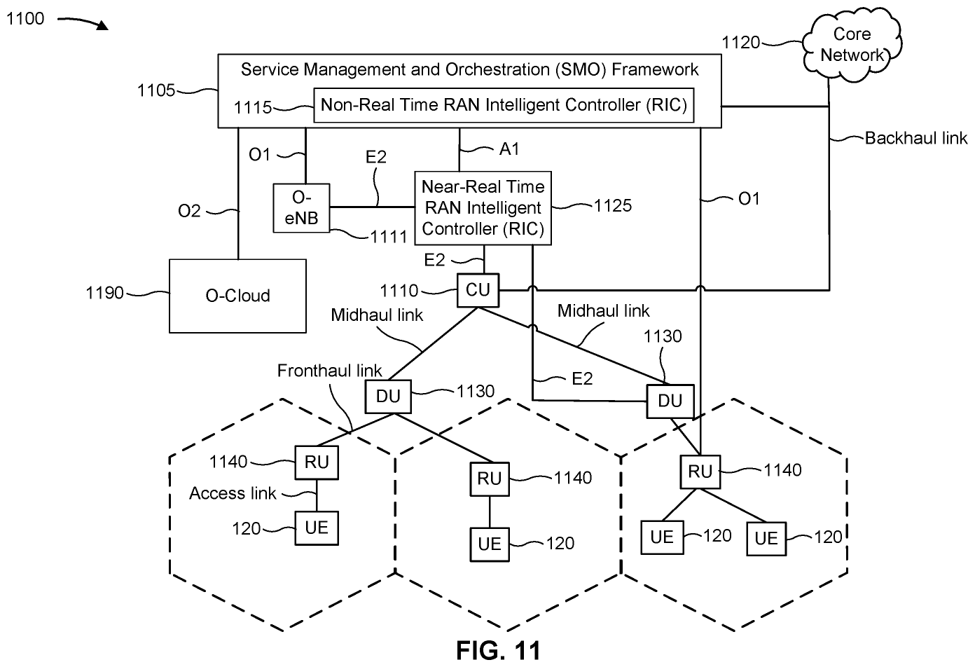

FIG. 11 is a diagram illustrating an example disaggregated base station architecture 1100, in accordance with the present disclosure. The disaggregated base station architecture 1100 may include a CU 1110 that can communicate directly with a core network 1120 via a backhaul link, or indirectly with the core network 1120 through one or more disaggregated control units (such as a Near-RT RIC 1125 via an E2 link, or a Non-RT RIC 1115 associated with a Service Management and Orchestration (SMO) Framework 1105, or both). A CU 1110 may communicate with one or more DUs 1130 via respective midhaul links, such as through F1 interfaces. Each of the DUs 1130 may communicate with one or more RUs 1140 via respective fronthaul links. Each of the RUs 1140 may communicate with one or more UEs 120 via respective radio frequency (RF) access links. In some implementations, a UE 120 may be simultaneously served by multiple RUs 1140.

Each of the units, including the CUs 1110, the DUs 1130, the RUs 1140, as well as the Near-RT RICs 1125, the Non-RT RICs 1115, and the SMO Framework 1105, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 1110 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 1110. The CU 1110 may be configured to handle user plane functionality (for example, Central Unit-User Plane (CU-UP) functionality), control plane functionality (for example, Central Unit-Control Plane (CU-CP) functionality), or a combination thereof. In some implementations, the CU 1110 can be logically split into one or more CU-UP units and one or more CU-CP units. A CU-UP unit can communicate bidirectionally with a CU-CP unit via an interface, such as the E1 interface when implemented in an O-RAN configuration. The CU 1110 can be implemented to communicate with a DU 1130, as necessary, for network control and signaling.

Each DU 1130 may correspond to a logical unit that includes one or more base station functions to control the operation of one or more RUs 1140. In some aspects, the DU 1130 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 1130 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 1130, or with the control functions hosted by the CU 1110.

Each RU 1140 may implement lower-layer functionality. In some deployments, an RU 1140, controlled by a DU 1130, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 1140 can be operated to handle over the air (OTA) communication with one or more UEs 120. In some implementations, real-time and non-real-time aspects of control and user plane communication with the RU(s) 1140 can be controlled by the corresponding DU 1130. In some scenarios, this configuration can enable each DU 1130 and the CU 1110 to be implemented in a cloud-based RAN architecture, such as a vRAN architecture.

The SMO Framework 1105 may be configured to support RAN deployment and provisioning of non-virtualized and virtualized network elements. For non-virtualized network elements, the SMO Framework 1105 may be configured to support the deployment of dedicated physical resources for RAN coverage requirements, which may be managed via an operations and maintenance interface (such as an O1 interface). For virtualized network elements, the SMO Framework 1105 may be configured to interact with a cloud computing platform (such as an open cloud (O-Cloud) platform 1190) to perform network element life cycle management (such as to instantiate virtualized network elements) via a cloud computing platform interface (such as an O2 interface). Such virtualized network elements can include, but are not limited to, CUs 1110, DUs 1130, RUs 1140, non-RT RICs 1115, and Near-RT RICs 1125. In some implementations, the SMO Framework 1105 can communicate with a hardware aspect of a 4G RAN, such as an open eNB (O-eNB) 1111, via an O1 interface. Additionally, in some implementations, the SMO Framework 1105 can communicate directly with each of one or more RUs 1140 via a respective O1 interface. The SMO Framework 1105 also may include a Non-RT RIC 1115 configured to support functionality of the SMO Framework 1105.

The Non-RT RIC 1115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1125. The Non-RT RIC 1115 may be coupled to or communicate with (such as via an A1 interface) the Near-RT RIC 1125. The Near-RT RIC 1125 may be configured to include a logical function that enables near-real-time control and optimization of RAN elements and resources via data collection and actions over an interface (such as via an E2 interface) connecting one or more CUs 1110, one or more DUs 1130, or both, as well as an O-eNB, with the Near-RT RIC 1125.

In some implementations, to generate AI/ML models to be deployed in the Near-RT RIC 1125, the Non-RT RIC 1115 may receive parameters or external enrichment information from external servers. Such information may be utilized by the Near-RT RIC 1125 and may be received at the SMO Framework 1105 or the Non-RT RIC 1115 from non-network data sources or from network functions. In some examples, the Non-RT RIC 1115 or the Near-RT RIC 1125 may be configured to tune RAN behavior or performance. For example, the Non-RT RIC 1115 may monitor long-term trends and patterns for performance and employ AI/ML models to perform corrective actions through the SMO Framework 1105 (such as reconfiguration via an O1 interface) or via creation of RAN management policies (such as A1 interface policies).

As indicated above, FIG. 11 is provided as an example. Other examples may differ from what is described with regard to FIG. 11.

The following provides an overview of some Aspects of the present disclosure:

Aspect 1: A method of wireless communication performed by a UE comprising: determining a power allocation for a first uplink transmission in a component carrier that at least partially overlaps in time with a second uplink transmission in the component carrier, wherein the power allocation is determined based at least in part on a priority order that includes a priority for index values associated with time-domain overlapping uplink transmissions in a same component carrier; and transmitting the first uplink transmission in the component carrier based at least in part on the power allocation.

Aspect 2: The method of Aspect 1, wherein a total maximum output power for a plurality of component carriers that includes the component carrier is not defined per index value.

Aspect 3: The method of any of Aspects 1-2, wherein a total maximum output power for a plurality of component carriers that includes the component carrier is to be shared among a plurality of panels of the UE.

Aspect 4: The method of any of Aspects 1-3, wherein the index values are CORESET pool index values.

Aspect 5: The method of any of Aspects 1-4, wherein each of the index values corresponds to a different panel of the UE.

Aspect 6: The method of any of Aspects 1-5, wherein the priority for the index values indicates that an uplink transmission having a first index value has a higher priority than an uplink transmission having a second index value.

Aspect 7: The method of any of Aspects 1-6, wherein the priority for the index values is lower in the priority order than a priority for PHY layer priority indices of uplink transmissions and is higher in the priority order than a priority for payload types of uplink transmissions.

Aspect 8: The method of any of Aspects 1-6, wherein the priority for the index values is higher in the priority order than a priority for PHY layer priority indices of uplink transmissions.

Aspect 9: The method of any of Aspects 1-6, wherein the priority for the index values is lower in the priority order than a priority for payload types of uplink transmissions.

Aspect 10: The method of any of Aspects 1-9, wherein the priority for the index values is lower in the priority order than a priority for PRACH transmissions in a primary component carrier.

Aspect 11: The method of any of Aspects 1-10, wherein the priority for the index values is higher in the priority order than a priority for SRS transmissions.

Aspect 12: The method of any of Aspects 1-11, wherein the priority for the index values indicates that an uplink transmission having a first index value has a higher priority than an uplink transmission having a second index value based at least in part on the uplink transmission having the first index value and the uplink transmission having the second index value at least partially overlapping in time on a given component carrier and having a same priority according to a legacy priority order.

Aspect 13: The method of any of Aspects 1-12, wherein the priority for the index values is applicable to primary cells only.

Aspect 14: The method of any of Aspects 1-12, wherein the priority for the index values is applicable to primary cells and secondary cells.

Aspect 15: The method of any of Aspects 1-15, further comprising determining a power allocation for the second uplink transmission based at least in part on the priority order that includes the priority for index values associated with time-domain overlapping uplink transmissions in a same component carrier.

Aspect 16: The method of Aspect 15, further comprising transmitting the second uplink transmission in the component carrier based at least in part on the power allocation for the second uplink transmission.

Aspect 17: A method of wireless communication performed by a UE, comprising: determining a power allocation for a first uplink transmission in a component carrier that at least partially overlaps in time with a second uplink transmission in the component carrier, wherein the power allocation is determined based at least in part on a priority order, and wherein the first uplink transmission is associated with a first index value associated with time-domain overlapping uplink transmissions in a same component carrier; and transmitting the first uplink transmission in the component carrier based at least in part on the power allocation.

Aspect 18: The method of Aspect 17, wherein a total maximum output power for a plurality of component carriers that includes the component carrier is defined for the first index value.

Aspect 19: The method of any of Aspects 17-18, wherein a total maximum output power for a plurality of component carriers that includes the component carrier is dedicated to a panel of the UE to be used for transmitting the first uplink transmission.

Aspect 20: The method of any of Aspects 17-19, wherein the first index value is a CORESET pool index value.

Aspect 21: The method of any of Aspects 17-20, wherein the first index value corresponds to a particular panel of the UE.

Aspect 22: The method of any of Aspects 17-21, further comprising associating the first uplink transmission with the first index value based at least in part on the first uplink transmission not explicitly being associated with an index value.

Aspect 23: The method of any of Aspects 17-22, further comprising determining a power allocation for the second uplink transmission based at least in part on the priority order, the second uplink transmission being associated with a second index value associated with time-domain overlapping uplink transmissions in a same component carrier, wherein the power allocation for the second uplink transmission is determined based at least in part on a total maximum output power for a plurality of component carriers that includes the component carrier defined for the second index value.

Aspect 24: The method of Aspect 23, further comprising transmitting the second uplink transmission in the component carrier based at least in part on the power allocation for the second uplink transmission.

Aspect 25: An apparatus for wireless communication at a device, comprising a processor; memory coupled with the processor; and instructions stored in the memory and executable by the processor to cause the apparatus to perform the method of one or more of Aspects 1-16.

Aspect 26: A device for wireless communication, comprising a memory and one or more processors coupled to the memory, the one or more processors configured to perform the method of one or more of Aspects 1-16.

Aspect 27: An apparatus for wireless communication, comprising at least one means for performing the method of one or more of Aspects 1-16.

Aspect 28: A non-transitory computer-readable medium storing code for wireless communication, the code comprising instructions executable by a processor to perform the method of one or more of Aspects 1-16.

Aspect 29: A non-transitory computer-readable medium storing a set of instructions for wireless communication, the set of instructions comprising one or more instructions that, when executed by one or more processors of a device, cause the device to perform the method of one or more of Aspects 1-16.

Aspect 30: An apparatus for wireless communication at a device, comprising a processor; memory coupled with the processor; and instructions stored in the memory and executable by the processor to cause the apparatus to perform the method of one or more of Aspects 17-24.

Aspect 31: A device for wireless communication, comprising a memory and one or more processors coupled to the memory, the one or more processors configured to perform the method of one or more of Aspects 17-24.

Aspect 32: An apparatus for wireless communication, comprising at least one means for performing the method of one or more of Aspects 17-24.

Aspect 33: A non-transitory computer-readable medium storing code for wireless communication, the code comprising instructions executable by a processor to perform the method of one or more of Aspects 17-24.

Aspect 34: A non-transitory computer-readable medium storing a set of instructions for wireless communication, the set of instructions comprising one or more instructions that, when executed by one or more processors of a device, cause the device to perform the method of one or more of Aspects 17-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
determine a power allocation for a first uplink transmission in a component carrier that at least partially overlaps in time with a second uplink transmission in the component carrier,
wherein the power allocation is determined based at least in part on a priority order that includes a priority for index values associated with time-domain overlapping uplink transmissions in a same component carrier; and
transmit the first uplink transmission in the component carrier based at least in part on the power allocation.

2. The UE of claim 1, wherein a total maximum output power for a plurality of component carriers that includes the component carrier is not defined per index value.

3. The UE of claim 1, wherein a total maximum output power for a plurality of component carriers that includes the component carrier is to be shared among a plurality of panels of the UE.

4. The UE of claim 1, wherein the index values are control resource set (CORESET) pool index values.

5. The UE of claim 1, wherein each of the index values corresponds to a different panel of the UE.

6. The UE of claim 1, wherein the priority for the index values indicates that an uplink transmission having a first index value has a higher priority than an uplink transmission having a second index value.

7. The UE of claim 1, wherein the priority for the index values is lower in the priority order than a priority for physical (PHY) layer priority indices of uplink transmissions and is higher in the priority order than a priority for payload types of uplink transmissions.

8. The UE of claim 1, wherein the priority for the index values is higher in the priority order than a priority for physical (PHY) layer priority indices of uplink transmissions.

9. The UE of claim 1, wherein the priority for the index values is lower in the priority order than a priority for payload types of uplink transmissions.

10. The UE of claim 1, wherein the priority for the index values is lower in the priority order than a priority for physical random access channel (PRACH) transmissions in a primary component carrier.

11. The UE of claim 1, wherein the priority for the index values is higher in the priority order than a priority for sounding reference signal (SRS) transmissions.

12. The UE of claim 1, wherein the priority for the index values indicates that an uplink transmission having a first index value has a higher priority than an uplink transmission having a second index value based at least in part on the uplink transmission having the first index value and the uplink transmission having the second index value at least partially overlapping in time on a given component carrier and having a same priority according to a legacy priority order.

13. The UE of claim 1, wherein the priority for the index values is applicable to primary cells only.

14. The UE of claim 1, wherein the priority for the index values is applicable to primary cells and secondary cells.

15. The UE of claim 1, wherein the one or more processors are further configured to determine a power allocation for the second uplink transmission based at least in part on the priority order that includes the priority for index values associated with time-domain overlapping uplink transmissions in a same component carrier.

16. The UE of claim 15, wherein the one or more processors are further configured to transmit the second uplink transmission in the component carrier based at least in part on the power allocation for the second uplink transmission.

17. A user equipment (UE) for wireless communication, comprising:
a memory; and
one or more processors, coupled to the memory, configured to:
determine a power allocation for a first uplink transmission in a component carrier that at least partially overlaps in time with a second uplink transmission in the component carrier,
wherein the power allocation is determined based at least in part on a priority order, and
wherein the first uplink transmission is associated with a first index value associated with time-domain overlapping uplink transmissions in a same component carrier; and
transmit the first uplink transmission in the component carrier based at least in part on the power allocation.

18. The UE of claim 17, wherein a total maximum output power for a plurality of component carriers that includes the component carrier is defined for the first index value.

19. The UE of claim 17, wherein a total maximum output power for a plurality of component carriers that includes the component carrier is dedicated to a panel of the UE to be used for transmitting the first uplink transmission.

20. The UE of claim 17, wherein the first index value is a control resource set (CORESET) pool index value.

21. The UE of claim 17, wherein the first index value corresponds to a particular panel of the UE.

22. The UE of claim 17, wherein the one or more processors are further configured to associate the first uplink transmission with the first index value based at least in part on the first uplink transmission not explicitly being associated with an index value.

23. The UE of claim 17, wherein the one or more processors are further configured to determine a power allocation for the second uplink transmission based at least in part on the priority order, the second uplink transmission being associated with a second index value associated with time-domain overlapping uplink transmissions in a same component carrier,
wherein the power allocation for the second uplink transmission is determined based at least in part on a total maximum output power for a plurality of component carriers that includes the component carrier defined for the second index value.

24. The UE of claim 23, wherein the one or more processors are further configured to transmit the second uplink transmission in the component carrier based at least in part on the power allocation for the second uplink transmission.

25. A method of wireless communication performed by a user equipment (UE), comprising:
determining a power allocation for a first uplink transmission in a component carrier that at least partially overlaps in time with a second uplink transmission in the component carrier,
wherein the power allocation is determined based at least in part on a priority order that includes a priority for index values associated with time-domain overlapping uplink transmissions in a same component carrier; and
transmitting the first uplink transmission in the component carrier based at least in part on the power allocation.

26. The method of claim 25, wherein a total maximum output power for a plurality of component carriers that includes the component carrier is not defined per index value.

27. The method of claim 25, wherein a total maximum output power for a plurality of component carriers that includes the component carrier is to be shared among a plurality of panels of the UE.

28. A method of wireless communication performed by a user equipment (UE), comprising:
determining a power allocation for a first uplink transmission in a component carrier that at least partially overlaps in time with a second uplink transmission in the component carrier,
wherein the power allocation is determined based at least in part on a priority order, and
wherein the first uplink transmission is associated with a first index value associated with time-domain overlapping uplink transmissions in a same component carrier; and
transmitting the first uplink transmission in the component carrier based at least in part on the power allocation.

29. The method of claim 28, wherein a total maximum output power for a plurality of component carriers that includes the component carrier is defined for the first index value.

30. The method of claim 28, wherein a total maximum output power for a plurality of component carriers that includes the component carrier is dedicated to a panel of the UE to be used for transmitting the first uplink transmission.
